(19) United States
(12) Patent Application Publication
(10) Pub. No.: US 2015/0371140 A1
(43) Pub. Date: Dec. 24, 2015

(54) Minimizing Symbolic Finite Automata

(71) Applicant: Microsoft Technology Licensing, LLC, Redmond, WA (US)

(72) Inventor: Margus Veanes, Bellevue, WA (US)

(21) Appl. No.: 14/313,697

(22) Filed: Jun. 24, 2014

(51) Int. Cl. G06N 5/04

(52) U.S. Cl. CPC G06N 5/04

(57) ABSTRACT

Techniques are provided herein for minimizing symbolic finite automata. The techniques for minimizing symbolic finite automata include the selection of a set of states, which may include a set of final states or a set of non-final states. By following the transitions from the selected states, techniques disclosed herein define partitions between various states of the SFA. Techniques are applied to the states in each partition to determine the states and state transitions of a minimized symbolic finite automaton. Techniques disclosed herein allow for the minimization of a symbolic finite automaton without the need to calculate minterms.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Automata, or state machines, may be used by computing devices to represent the states, actions and transitions of a computer program. In addition, automata may be used in various ways to define or model data. For instance, automata may be used to express validity constraints on strings, which may include a wide range of applications, including program analysis and parameterized unit testing of code.

By way of example, consider the ways in which a software program tests a pattern of characters against one or more constraints. In some scenarios, a program may have a need to test a large number of random strings against a given constraint. One problem with this method is that it is an inefficient use of computational resources to process constraints. The problem may be exacerbated when such a process involves a combination of constraints.

Automata may also be used in many different contexts, such as unit testing of code, database query analysis, web applications, and so forth. For example, automata may be used in the context of symbolic analysis of database queries, where like-patterns are a type of expression that may be common in structured query language (“SQL”) select statements. Such uses of automata, and other uses, may lead to complex data structures. In some instances, the data structures representing automata may be so large, general computing devices may be challenged to utilize automata-based technologies, at least in a manner that may be computationally efficient.

It is with respect to these and other considerations that the disclosure made herein is presented.

### SUMMARY

According to various embodiments, techniques are provided herein for minimizing symbolic finite automata (“SFA”). The techniques for minimizing symbolic finite automata include the selection of a set of states, which may include a set of final states or a set of non-final states. By following the transitions from the selected states, techniques disclosed herein define partitions between various states of the SFA. Techniques are applied to the states in each partition to determine the states and state transitions of a minimized symbolic finite automaton. Techniques disclosed herein allow for the minimization of a symbolic finite automaton without the need to calculate minterms.

It should be appreciated that the above-described subject matter may also be implemented as a computer-controlled apparatus, a computer process, a computing system, or as an article of manufacture such as a computer-readable storage medium. These and various other features will be apparent from a reading of the following Detailed Description and a review of the associated drawings. Although the techniques and some of the examples disclosed herein describe techniques for minimizing symbolic finite automata, it can be appreciated that the techniques disclosed herein may also apply to other applications using symbolic finite automata.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a flow diagram illustrating an example routine for minimizing a symbolic finite automaton;

FIG. 2 shows an example symbolic finite automaton to be processed by the routine shown in FIG. 1;

FIG. 3 shows a first partition that is applied to the example symbolic finite automaton shown in FIG. 2;

FIG. 4 shows a second partition and a refining partition that are applied to the example symbolic finite automaton shown in FIG. 2;

FIG. 5 shows a third partition and a fourth partition that are applied to the example symbolic finite automaton shown in FIG. 2;

FIG. 6 shows a minimized symbolic finite automaton based on the example symbolic finite automaton shown in FIG. 2;

FIGS. 7A-7B show example symbolic finite automata having variations that apply to refining partitions; and

FIG. 8 is a computer architecture diagram showing an illustrative computer hardware architecture for a computing system capable of implementing the technologies presented herein.

### DETAILED DESCRIPTION

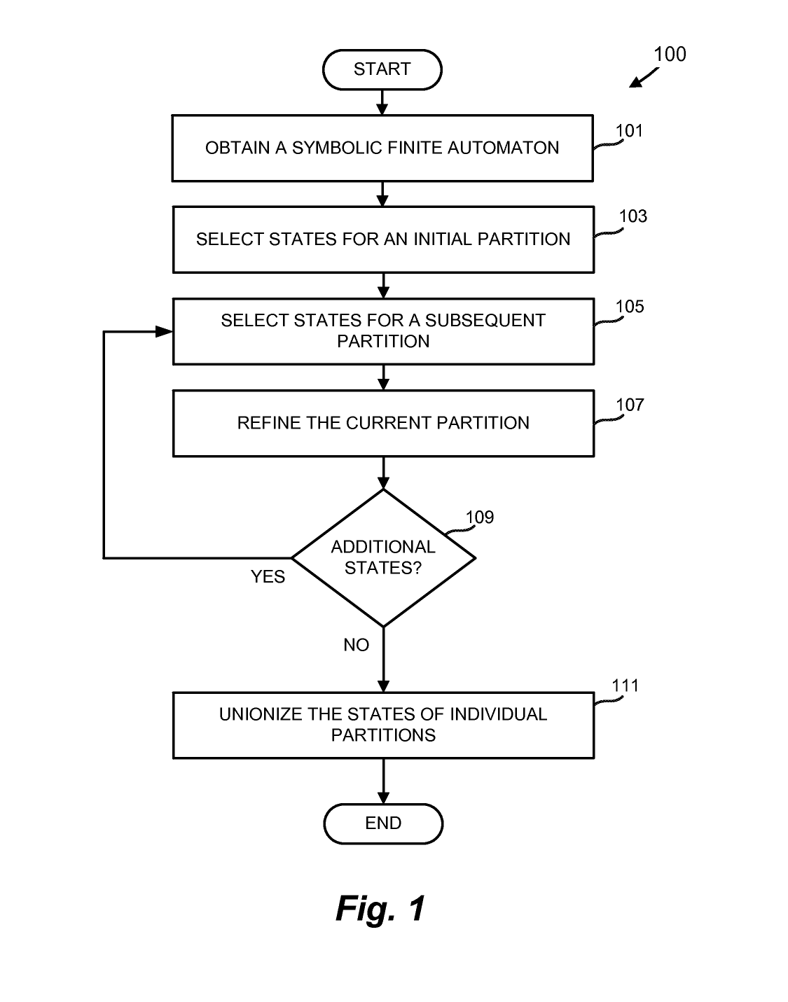

According to various embodiments, techniques are provided herein for minimizing complex symbolic finite automata (“SFA”). The techniques for minimizing symbolic finite automata include the selection of a set of states, which may include a set of final states or a set of non-final states. By following the transitions from the selected states, techniques disclosed herein define partitions between various states of the SFA. An over-approximation technique is applied to the states in each partition to determine the states and state transitions of a minimized symbolic finite automaton. Techniques disclosed herein allow for the minimization of a symbolic finite automaton without the need to calculate minterms. Additional details regarding these and other aspects of the technologies presented herein will be provided below with regard to FIGS. 1-8.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements throughout the several figures, aspects of a computing system and methodology for minimizing symbolic finite automata will be described.

Referring now to FIG. 1, a flow diagram showing aspects of one illustrative routine 100 for minimizing a SFA is shown and described. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein. It also should be understood that the illustrated methods can be ended at any time and need not be performed in its entirety.

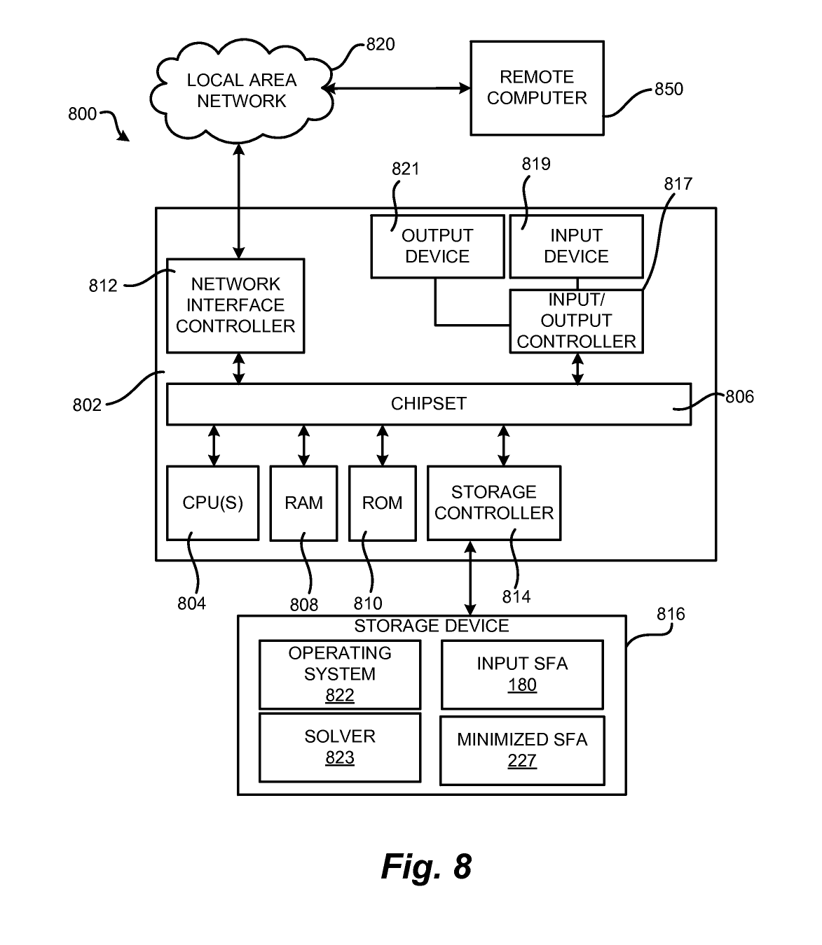

Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Although the techniques described herein may be implemented in a number of ways, for illustrative purposes, the routines and operations described herein are performed on a software module referred to as a solver (823 of FIG. 8). This example is provided for illustrative purposes and is not to be construed as limiting, as it can be appreciated that the techniques described herein may be implemented on other modules, multiple modules and/or multiple computing devices.

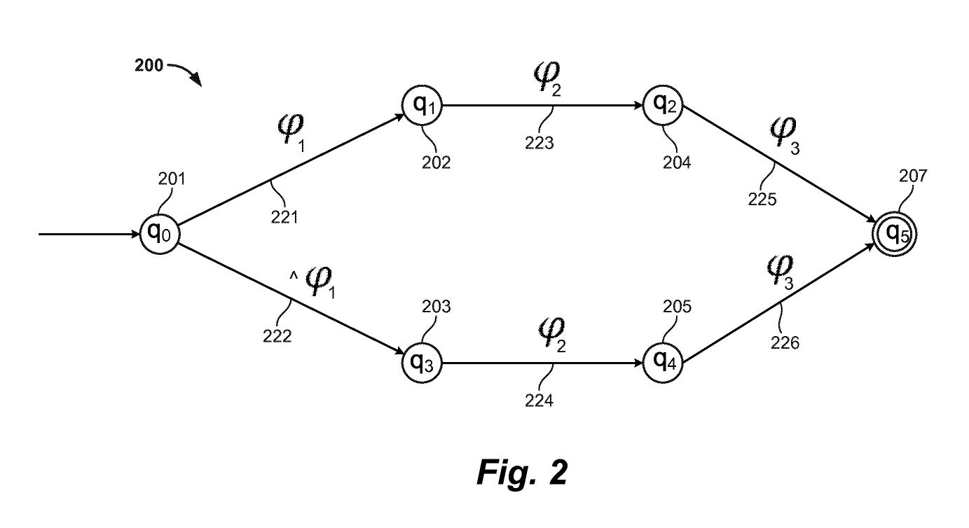

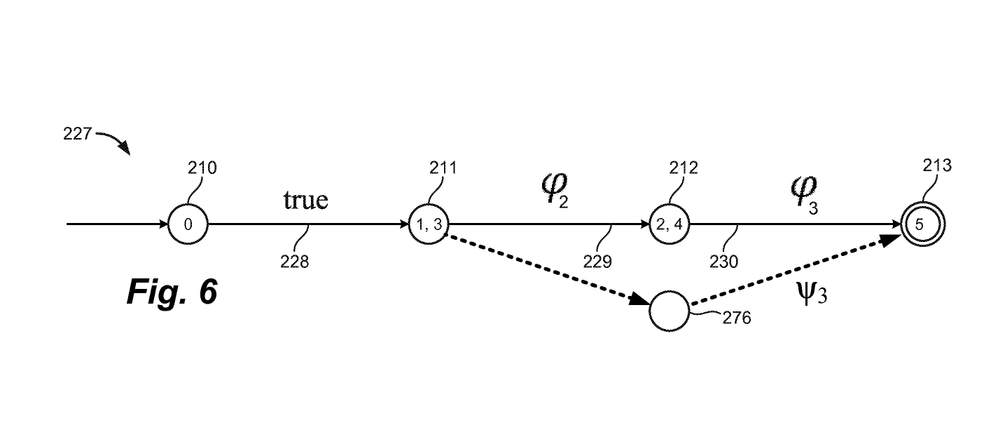

The flow diagram of FIG. 1 shows aspects of one illustrative routine 100 for minimizing a SFA is shown and described. The following description also refers to an example SFA 200 of FIGS. 2-5. In brief, the illustrative routine 100 examines the example SFA 200 and selects particular groupings of states for individual partitions. Based on an over-approximation technique, the example SFA 200 is processed to generate a minimized SFA 227 shown in FIG. 6.

The routine 200 begins at operation 101 where the solver 823 obtains data defining a SFA. As can be appreciated, a number of data formats may be used to define, model or represent a SFA. In one example, an input tool may be used to define a regular expression and the regular expression may be converted into an SFA using one of many known methods. One example of an input tool includes a program referred to as a “Pex” tool. As a matter of background, a regular expression, also referred to herein as a “REGEX”, is a sequence of characters that define text patterns.

As can be appreciated, methods for generating a SFA from a regular expression is based on known algorithms for converting a regular expression into a finite automaton with epsilon moves. Additional information describing regular expressions and SFAs is provided in U.S. Pat. No. 8,515,891, the disclosure of which is incorporated herein by reference.

Referring momentarily to FIG. 2, a sample SFA 200 that may be obtained in operation 101 will be described. As shown, the sample SFA 200 comprises six states 201-207 and six state transitions 221-226 with corresponding predicates. In this example SFA 200, state transition 221 is associated with a predicate of (φ₁, state transition 222 is associated with a predicate of ̂φ₁, state transitions 223 and 224 are both is associated with a predicate of φ₂, and state transitions 225 and 226 are both associated with a predicate φ₃.

Turning back to FIG. 1, once an SFA is obtained in operation 101, the routine 100 continues to operation 103 where the solver 823 selects states for an initial partition. In one aspect of operation 103, the solver 823 divides the states of the example SFA 200 into two categories: final states and non-final states. The solver 823 then selects one of the two categories of states (i.e. final states or non-final states) for the initial partition, which is also referred to herein as the “first partition.” In general, either category of the states can be selected for the initial partition. In one embodiment, the solver 823 selects the category with the fewest states to be included in the initial partition.

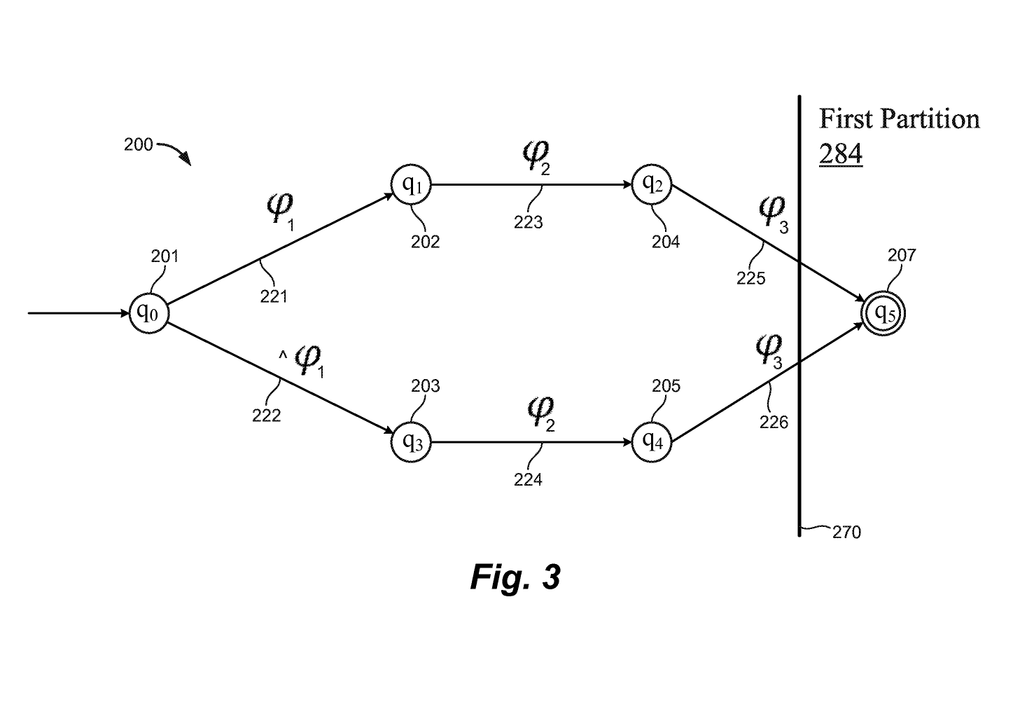

In applying the example SFA 200 of FIG. 2 to operation 103, since the q₅ state 207 is the only final state, the solver 823 places the q₅ state 207 in a first category, and all other non-final states 201-205 in a second category. In applying one embodiment of the operation 103, the embodiment where the category having the fewest states is selected for the initial partition, since the first category has only one state, the q₅ state 207, and the second category has five states, states 201-205, the q₅ state 207 is selected for the initial partition. For illustrative purposes, FIG. 3 shows a pictorial representation of the initial partition, referred to herein as “the first partition 284,” which is defined by the first partition boundary 270. As applied in the current example, the q₅ state 207 is included in the initial partition.

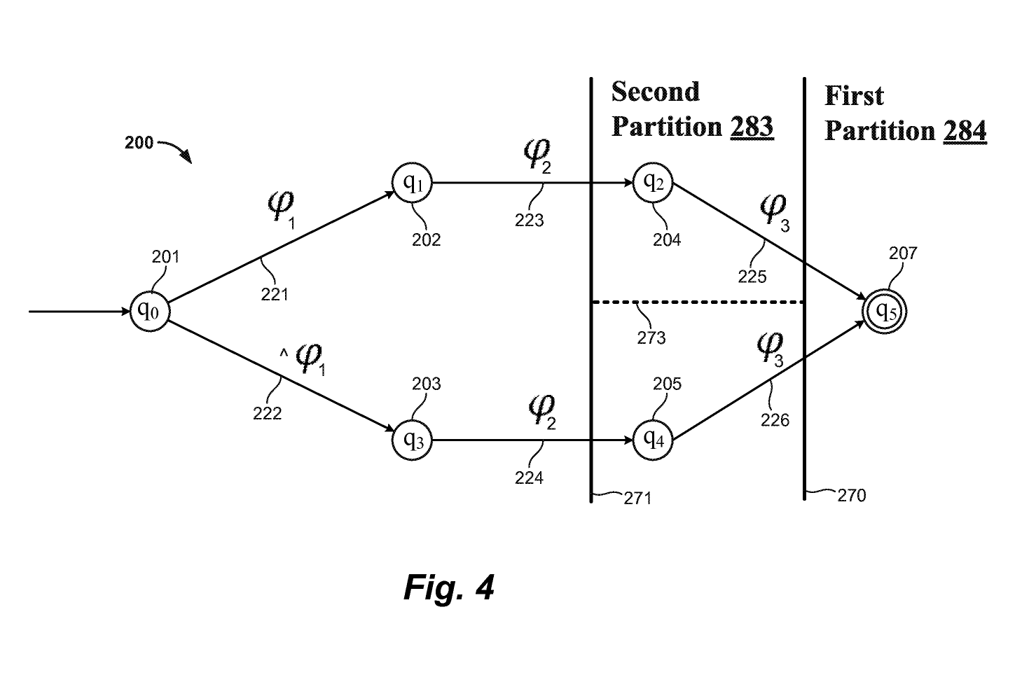

Next, at operation 105, the solver 823 selects a second set of states to be included in a subsequent partition. Generally described, operation 105 includes the selection of one or more states that have state transitions leading into the states of the initial partition. Thus, in applying operation 105 to the example SFA 200, the q₂ state 204 and the q₄ state 205 both have state transitions 225 and 226 leading into the state (q₅ state 207) included in the initial partition. Thus, q₂ state 204 and the q₄ state 205 are both selected for the subsequent partition, which in this example is referred to as the “second partition 283.” For illustrative purposes, the second partition boundary 271 is shown in FIG. 4, which shows the boundary for the second partition 283.

Next, at operation 107, the solver 823 refines the subsequent partition. Generally described, in operation 107, the subsequent partition may be split to create additional partitions if the states included in the subsequent partition do not have equivalent predicates. As can be appreciated, generally known techniques for determining the existence of equivalent predicates may be used in operation 107. As can be appreciated, the term “subsequent partition” refers to the partition after the initial partition processed in operation 103. As described in more detail below, the “subsequent partition” may also refer to partitions processed in subsequent iterations of operations 105-109.

For illustrative purposes, FIG. 4 provides an example of how operation 107 may be applied to the example SFA 200. As shown, the q₂ state 204 and the q₄ state 205 are both included in the subsequent partition, the second partition 283. As also shown, the q₂ state 204 and the q₄ state 205 both have state transitions leading to the q₅ state 207, where each state has the same value of φ₃. Given these conditions, and given that the q₂ state 204 and the q₄ state 205 both have state transitions leading to states in the same partition, the solver 823 would determine that the predicates of the states included in the subsequent partition are equivalent, and the subsequent partition would not be split.

To illustrate the concepts of the refining process of operation 107, another example is provided herein to show how the subsequent partition, e.g., the second partition 283, would be split. In such a scenario, the second partition would be split if states of the subsequent partition have predicates that are not equivalent. For example, if the state transition 226 had the value of ψ₃ instead of φ₃, the q₂ state 204 and the q₄ state 205 would not have equivalent predicates. Thus, given this scenario, the solver 823 would create a refining partition boundary 273 to split the second partition 283 into two different partitions. As described in more detail below, a split of the second partition may impact the outcome of the minimized SFA.

Returning to FIG. 1, next, at operation 109 the solver 823 determines if there are additional states in the SFA to process. In one embodiment, the solver 823 determines if additional states exist by searching for states that lead into the states of the current partition. For example, the solver 823 may examine the SFA and determine if there are any states that lead into the states included in the partition processed in the previous iteration of operation 107. If any preceding states exist, the routine 100 returns to operation 105 where the solver 823 selects states of another subsequent partition.

An illustration of operation 109 is shown in FIG. 4, where the q₂ state 204 and the q₄ state 205 are included in the second partition 283, e.g., the current partition. As shown, in the examination of the states of the current partition, the solver 823 would determine that the SFA has states that lead into the states of the current partition: the q₁ state 202 and the q₃ state 203. As applied to the example SFA 200, given the existence of these preceding states, operation 109 would determine that there are additional states to examine. Thus, the routine 100 would return to operation 105 for a second iteration of operation 105.

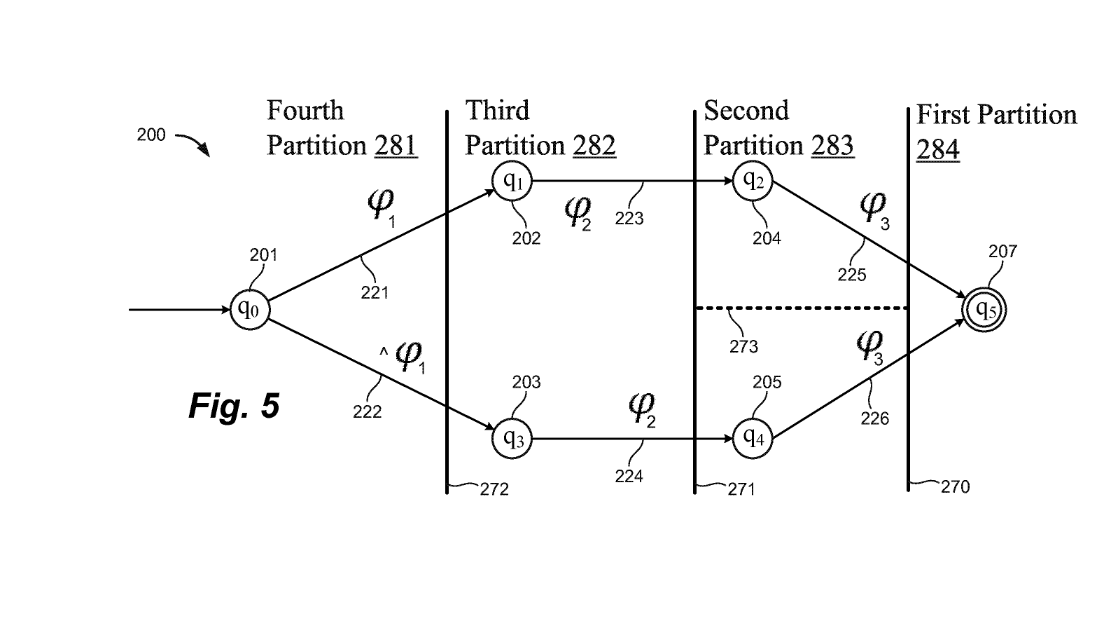

In the second iteration of operation 105, the solver 823 would select the q₁ state 202 and the q₃ state 203 for the next subsequent partition because the q₁ state 202 and the q₃ state 203 both lead to the states of the second partition 283. With reference to FIG. 5, the second pass of operation 105 would create the third partition 282, which is defined by the partition third partition boundary 272 and the second partition boundary 271.

Next, in applying the example SFA 200 to the second iteration of operation 105, once states are selected for the subsequent partition, the routine 100 proceeds to operation 107 where the solver 823 refines the new subsequent partition. In applying the example SFA 200 to the second iteration of operation 107, the solver 823 examines the states of the third partition 282 to determine if they have equivalent predicates. Given that the state transitions exiting the q₁ state 202 and the q₃ state 203 have the same value, φ₂, and that they both have exiting transitions leading to states in the same partition, the second partition 283, the solver 823 would determine that the states of the third partition 282 are equivalent, and thus, the third partition 282 would not be split into multiple partitions.

Returning to FIG. 1, in further processing of the example SFA 200, routine 100 continues processing until the q₀ state 201 is processed in the manner described above, after which, at operation 109, the solver 823 would determine that there are no additional states to examine. The routine 100 then proceeds to operation 111 where the solver 823 unionizes the states of the individual partitions. As can be appreciated, a number of known methods for unionizing, also referred to as “normalizing,” states and state transitions can be applied to execute operation 111. Generally described, the states of each partition are analyzed and individual states and state transitions of each partition are collapsed and merged.

As can be appreciated, routine 100 may include a number of operations subsequent to operation 111. For instance, the diagram depicted in FIG. 1 may include a processing, display or communication operation following operation 111. In such an operation, the resulting minimized SFA 227 may be displayed on a display or other output device, such as the output device 821 of FIG. 8. In addition, the resulting minimized SFA 227 may be communicated to one or more components of the computing device. In addition, the resulting minimized SFA 227 may be communicated to another computer, such as the remote computer 850 of FIG. 8, for further processing. These example are provided for illustrative purposes and are not to be construed as limiting, as it can be appreciated that routine 100 may include any operation to process, communicate, store and/or display the resulting minimized SFA 227.

FIG. 6 illustrates one example of a resulting minimized SFA 227 from operation 111. As shown, the states and state transitions of the second partition 283 are collapsed and merged to form the (2,4) state 212, which has an exiting state transition with a value of φ₃. This result is from the union of the state transitions 225 and 226 of FIG. 5. In addition, the (1,3) state 211 has an exiting state transition with a value of φ₂, which is from the union of the state transitions 223 and 224. In addition, the (0) state 210 has an exiting state transition with the value of TRUE, which is from the union of the state transitions 221 and 222. As shown in FIG. 6, the resulting SFA 227 is minimized. In this example, the resulting minimized SFA 227 comprises four (4) states 210-213 and three resulting state transitions 228-230.

FIG. 6 also shows an additional state 276 which would result in the above-described example with a different value, ψ₃, (not shown in FIG. 5) at the state transition 226 exiting the q₄ state 205. As summarized above, this example was provided to show how operation 105 processes two states of the same partition that have non-equivalent predicates. When this example scenario is applied to the example SFA 200, the second partition is split with refining partition boundary 273 (shown in FIG. 5). The refining partition boundary 273 illustrates that the q₂ state 204 and the q₄ state 205 are split into separate partitions since, in this example, they do not have equivalent predicates. In the unionizing process of operation 109 of this example, the resulting SFA 227 would also include the additional state 276, which also includes an exiting state transition having a value of ψ₃.

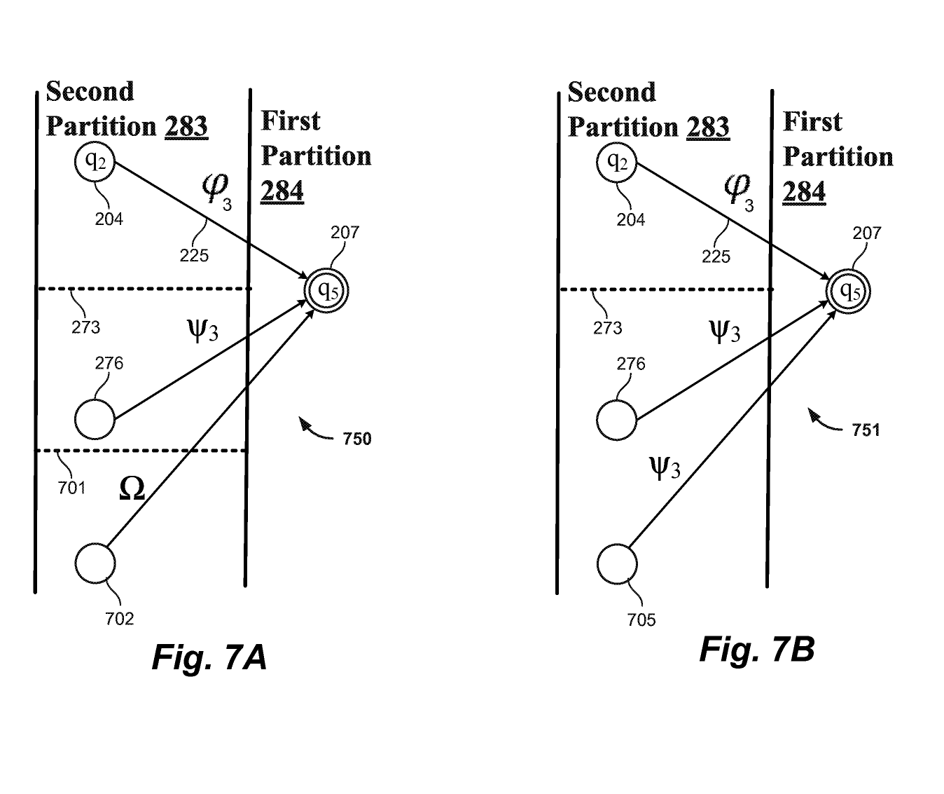

In another variation of the example SFA 200, FIG. 7A shows a portion of another example SFA 750, which is used to illustrate how the refining partitions may be applied to other configurations. In this example, the example SFA 750 includes three states 204, 276 and 202 with transitions leading to the final state 207. Also shown, the states 204, 276 and 702 have non-equivalent predicates, respectively φ₃, ψ₃ and Ω.

In applying the above-described techniques to the example SFA 750 of FIG. 7A, refining partitions, defined by refining partition boundary 273 and refining partition boundary 701, are created to separate each of the states 204, 276 and 702 since the three states 204, 276 and 702 of the second partition 283 have non-equivalent predicates. As shown in this illustrative example, the refining partition boundary 273 separates state 204 and 276, and the second refining partition boundary 201 separates state 276 and 702.

In another variation of the example SFA 200, FIG. 7B shows a portion of another example SFA 751 that includes three states 204, 276 and 205 with transitions leading to the final state 207. As also shown, the predicates of the states 204, 276 and 705 are respectively φ₃, ψ₃ and ψ₃. In applying the above-described techniques to the example SFA 751 of FIG. 7B, a refining partition 273 is created to separate state 204 from the other two states 276 and 705. As shown, the states having equivalent predicates share the same partition, and the state having a non-equivalent predicate is in a separate partition.

For illustrative purposes, example program code (“code”) for performing a minimization process is provided below. To illustrate this embodiment of the minimization process, the description following the example code set forth in Table 2 also refers to the example SFA 200 of FIGS. 2-5.

TABLE 2

| | |
|---|---|
| Line 1: | Min_{SFA}^{N} (M = ( [symbol] , [symbol] , q⁰, F, Δ)) [symbol] |
| Line 2: | [symbol] :={F, [symbol] \ F}; //initial partition |
| Line 3: | W := {if (\|F\| ≦ \| [symbol] \ F\|) then F else [symbol] \ F}; |

| | |
|---|---|
| Line 4: | while (W ≠ ø) //main loop |

| | |
|---|---|
| Line 5: | [symbol] := choose (W); W := W \ { [symbol] }; |
| Line 6: | S := δ⁻¹(T, [symbol] ); //all states leading into [symbol] |
| Line 7: | Γ := {p → V_{(p,φ,-)∈}_{_{Δ}}_{←(R)} φ}p∈s; //maps p to the pred. |
| | into [symbol] |
| Line 8: | while (exists (P in [symbol] ) where P ∩ S ≠ ø and P \ S ≠ ø) |
| Line 9: | [symbol] [symbol] , W [symbol] := Split_{p,w} (P, P ∩ S, P \ S); |
| | //(_, [symbol] )-split |
| Line 10: | while (exists (P in [symbol] ) where P ∩ S ≠ ø and |

| | |
|---|---|
| Line 11: | (exists (p1, p2 in P) where lsSat ( [symbol] (Γ(p1)) [symbol] |
| | Γ(p2)))) |

| | |
|---|---|
| Line 12: | a := choose ([[ [symbol] (Γ(p1) [symbol] Γ(p2))]]); |
| Line 13: | P₁ := {p ∈ P\|a ∈ [[Γ(p)]]}; |
| Line 14: | [symbol] [symbol] , W [symbol] := Split [symbol] _{,W} (P, P₁, P \ P₁); //(a, [symbol] )-split |

| | |
|---|---|
| Line 15: | return M_{/≡} [symbol] ; |

As described above and represented in operation 101 of FIG. 1, the solver 823 determines an initial partition. This step is represented in Line 2 of the sample code shown in Table 2, where the solver 823 divides the states of the example SFA 200 into two categories: a first category having final states and a second category having non-final states. The symbol [symbol] represents a partitioning that separates the final states (F) from the non-final states (Q\F). In addition, as shown in Line 3 of the sample program code shown in Table 2, if the first category of states has fewer or an equal number of states, the first category of states is selected for a work item, where W represents the current work item. As mentioned above, some configurations provided herein do not require the selection of the category having fewer states, as this is only one way of implementing the minimization techniques.

With reference to the example SFA 200 of FIG. 2, since the q₅ state 207 is a final state, the solver 823 places the q₅ state 207 in one category, and all other non-final states 201-205 in another category. With reference to the sample code shown in Table 2, the second category of states 201-205 associated with the non-final set “(Q\F)” and the first category of states, which includes the q₅ state 207, are associated with the final set (F). For illustrative purposes FIG. 3 illustrates a pictorial representation of the first partition 284, which is symbolized as, “={F, Q\F}”. In applying the example of FIG. 2, given there are fewer final states than non-final states, the final state, q₅ state 207, is included in the first partition 284.

The above-described operations are symbolized in the sample code shown in Table 2 in a manner that allows the solver 823 to maintain a list of work items. The vertical bars on each side of the variable indicate that the condition is based on a count of states. Thus, in accordance with Line 3 of the program code shown in Table 2, the current work item is the final set (F) if the number of final states “|F|” is less than or equal to the number of non-final states “|Q\F|”. However, if the number of final states “|F|” is not less than or equal to the number of non-final states “|Q\F|”, then the current work item is the non-final set (Q\F). In applying the above-described example to the sample code, since the final set (F) contains only one state, e.g., the q₅ state 207, and the non-final set (Q\F) contains five states, e.g., states 201-205, the current work item includes the final state, which can be symbolized as “W:=F”. Since the work item is not equal to a null value, the “while” loop continues processing the work item.

Line 5 of the sample code shown in Table 2 illustrates how the list of work items can be maintained. As shown in the sample code, the variable, [symbol] , is assigned the value of the current work item, and the current work item variable, W, is reset for the next iteration of the loop. As applied to the example SFA 200, in this iteration of the process, [symbol] is equal to the final set (F), which includes the q₅ state 207.

Next, at Line 6 of the sample code shown in Table 2, the solver 823 identifies the states that lead into the state or states being processed, e.g., an identification of all states leading into [symbol] . An example implementation of this operation is shown, where the S variable is equal to all of the states leading into [symbol] . This implementation describes, in part the operation 105 of FIG. 6, where states are selected based on the leading state transition. In applying the example SFA 200 to this example, S is equal to the q₂ state 204 and the q₄ state 205 since they both lead into the final state.

Next, Line 7 of the code in Table 2, the solver 823 maps the value of each transition leading into the state or states being processed, e.g., a map of all values leading into [symbol] . In this example, Gamma, F, includes a map of the transition values of S. More specifically, the symbolic representations of Line 8 show that Gamma is a map of every element in S, which is also referred to as a union of all the predicates that lead into [symbol] . In applying the example SFA 200 to operation 109, given the value of [symbol] , which includes the 5th state 207, and the value of S, which includes the q₂ state 204 and the q₄ state 205, Gamma, Γ, is {q₂ [symbol] φ₃, q₄ [symbol] φ₃}.

Next, at Lines 8 and 9, the sample code shown in Table 2 determines if the predicates of the q₂ state 204 and the q₄ state 205 are equivalent, if they are not equivalent, a split of the partition is performed. As described above, as applied to the example SFA 200, since the predicates of the q₂ state 204 and the q₄ state 205 are equivalent, the partition is not split. The second “while” command at Line 10 also represents a second test to determine if states referenced in the work item have equivalent predicates.

As with the processing of Lines 8 and 9, at Lines 10-14, if it is determined that the states referenced in the work item do not have equivalent predicates, the partition is split to separate the states that do not have equivalent predicates. The sample code shown in Table 2 is configured to cycle through the states of the SFA until there are no more states to process in the work item. By cycling through the iterations of the code, the partitions 281-284 shown in FIG. 5 are generated.

Once the partitions are determined, the normalization process, e.g., the unionization, of the states sharing individual partitions is performed. As described above, known methods for unionizing or normalizing groups of particular states can be used to implement this part of the process. As described above, the resulting minimized SFA 227 as shown in FIG. 6 comprises only four (4) states 210-213 and three resulting state transitions 228-230. The state transition 228 has a value of TRUE value. The state transition 229 is has a value of φ₂ and the state transition 230 has a value of φ₃.

For illustrative purposes, another example of program code for implementing the algorithm described above is provided in Table 3 for performing the minimization process. Aspects of the code shown below in Table 3 illustrate features, and other aspects, of the above-described embodiments. Other implementations might also be utilized.

TABLE 3
MinSFA (Automaton)
{

var fB = new Block(fa.GetFinalStates( ));
var nfB = new Block(fa.GetNonFinalStates( ));
var blocks = new Dictionary<int, Block>( );
foreach (var q in fa.GetFinalStates( )) blocks[q] = fB;
foreach (var q in fa.GetNonFinalStates( )) blocks[q] = nfB;
var W = new BlockStack( );
if (nfB.Count < fB.Count) W.Push(nfB); else W.Push(fB);
while (!W.IsEmpty) {

var R = W.Pop( );
varG = ...
var S = G.Keys;
var relevant = ...
foreach (var P in relevant){

var P1 = ...
if (P1.Count < P.Count) {

foreach (var p in P1) { P.Remove(p); blocks[p] = P1;}
if (W.Contains(P)) W.Push(P1);
else if (P.Count <= P1.Count) W.Push(P);
else W.Push(P1);

}}
bool iterate = true;
while (iterate) {

iterate = false;
relevant = ...
foreach (var P in relevant) {

var P1 = new Block( );
var psi = G[P.Current];
bool splitterFound = false;
P1.Add(P.Current);
while (P.MoveNext( )) {

```
  var q = P.Current;
  var phi = G[q];
  if (splitterFound) {
```

if (IsSat(psi & phi)) { P1.Add(q); psi = psi
& phi;}

} else {

if (IsSat(psi & !phi)) {

psi = psi & !phi;
splitterFound = true;

} else {

if (IsSat(phi & !psi)) {

P1.Clear( ); P1.Add(q);
psi = phi & !psi;
splitterFound = true;

} else P1.Add(q);

}}}
if (P1.Count < P.Count) {

iterate = (iterate || (P.Count > 2));
foreach (var p in P1) { P.Remove(p); blocks[p] =
P1; }
if (W.Contains(P)) W.Push(P1);
else if (P.Count <= P1.Count) W.Push(P);
else W.Push(P1);

}}}}}

FIG. 8 shows an example computer architecture for a computing device 800 capable of processing the techniques disclosed herein. The computer architecture shown in FIG. 8 illustrates a conventional server computer, workstation, desktop computer, laptop, tablet, phablet, network appliance, personal digital assistant (“PDA”), e-reader, digital cellular phone, or other computing device, and may be utilized to execute any of the software components presented herein. For example, the computer architecture shown in FIG. 8 may be utilized to execute any of the software components described above.

The computing device 800 includes a baseboard 802, or “motherboard,” which is a printed circuit board to which a multitude of components or devices may be connected by way of a system bus or other electrical communication paths. In one illustrative embodiment, one or more central processing units (“CPUs”) 804 operate in conjunction with a chipset 806. The CPUs 804 may be standard programmable processors that perform arithmetic and logical operations necessary for the operation of the computing device 800.

The CPUs 804 perform operations by transitioning from one discrete, physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and the like.

The chipset 806 provides an interface between the CPUs 804 and the remainder of the components and devices on the baseboard 802. The chipset 806 may provide an interface to a RAM 808, used as the main memory in the computing device 800. The chipset 806 may further provide an interface to a computer-readable storage medium such as a read-only memory (“ROM”) 810 or non-volatile RAM (“NVRAM”) for storing basic routines that help to startup the computing device 800 and to transfer information between the various components and devices. The ROM 810 or NVRAM may also store other software components necessary for the operation of the computing device 800 in accordance with the embodiments described herein.

The computing device 800 may operate in a networked environment using logical connections to remote computing devices and computer systems through a network, such as the local area network 820. The chipset 806 may include functionality for providing network connectivity through a network interface controller (NIC) 812, such as a gigabit Ethernet adapter. The NIC 812 is capable of connecting the computing device 800 to other computing devices over the network 820. It should be appreciated that multiple NICs 812 may be present in the computing device 800, connecting the computer to other types of networks and remote computer systems. The local area network 820 allows the computing device 800 to communicate with remote services and servers, such as a remote computer 850.

The computing device 800 may be connected to a mass storage device 816 that provides non-volatile storage for the computing device. The mass storage device 816 may store system programs, application programs, other program modules, and data, which have been described in greater detail herein. The mass storage device 816 may be connected to the computing device 800 through a storage controller 814 connected to the chipset 806. The mass storage device 816 may consist of one or more physical storage units. The storage controller 814 may interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units. It should also be appreciated that the mass storage device 816, other storage media and the storage controller 814 may include MultiMediaCard (MMC) components, eMMC components, Secure Digital (SD) components, PCI Express components, or the like.

The computing device 800 may store data on the mass storage device 816 by transforming the physical state of the physical storage units to reflect the information being stored. The specific transformation of physical state may depend on various factors, in different implementations of this description. Examples of such factors may include, but are not limited to, the technology used to implement the physical storage units, whether the mass storage device 816 is characterized as primary or secondary storage, and the like.

For example, the computing device 800 may store information to the mass storage device 816 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 800 may further read information from the mass storage device 816 by detecting the physical states or characteristics of one or more particular locations within the physical storage units.

In addition to the mass storage device 816 described above, the computing device 800 may have access to other computer-readable storage media to store and retrieve information, such as program modules, data structures, or other data. Thus, although the solver 823, the input SFA 180, the minimized SFA 227 and other modules are depicted as data and software stored in the mass storage device 816, it should be appreciated that the solver 823, the input SFA 180, the minimized SFA 227 and/or other modules may be stored, at least in part, in other computer-readable storage media of the device 800 and/or another computing device. Although the description of computer-readable media contained herein refers to a mass storage device, such as a solid state drive, a hard disk or CD-ROM drive, it should be appreciated by those skilled in the art that computer-readable media can be any available computer storage media or communication media that can be accessed by the computing device 800.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the computing device 800. For purposes of the claims, the phrase “computer storage medium,” “computer-readable storage medium,” and variations thereof, does not include waves or signals per se and/or communication media.

The mass storage device 816 may store an operating system 822 utilized to control the operation of the computing device 800. According to one embodiment, the operating system comprises the LINUX operating system. According to another embodiment, the operating system comprises the WINDOWS® operating system from MICROSOFT Corporation. According to further embodiments, the operating system may comprise the UNIX, Android, Windows Phone or iOS operating systems. It should be appreciated that other operating systems may also be utilized. The mass storage device 816 may store other system or application programs and data utilized by the computing device 800, such as the solver 823, the input SFA 180, the minimized SFA 227 and/or any of the other software components and data described above. The mass storage device 816 might also store other programs and data not specifically identified herein.

In one embodiment, the mass storage device 816 or other computer-readable storage media is encoded with computer-executable instructions which, when loaded into the computing device 800, transform the computer from a general-purpose computing system into a special-purpose computer capable of implementing the embodiments described herein. These computer-executable instructions transform the computing device 800 by specifying how the CPUs 804 transition between states, as described above. According to one embodiment, the computing device 800 has access to computer-readable storage media storing computer-executable instructions which, when executed by the computing device 800, perform the various routines described above with regard to FIG. 1. The computing device 800 might also include computer-readable storage media for performing any of the other computer-implemented operations described herein.

The computing device 800 may also include one or more input/output controllers 817 for receiving and processing input from an input device 819. The input device 819 may include a number of input devices, such as a keyboard, a mouse, a microphone, a headset, a touchpad, a touch screen, an electronic stylus, or any other type of input device. Similarly, the input/output controller 817 may provide output to an output device 821, such as a computer monitor, a flat-panel display, a digital projector, a printer, a plotter, or other type of output device. It will be appreciated that the computing device 800 may not include all of the components shown in FIG. 8, may include other components that are not explicitly shown in FIG. 8, or may utilize an architecture completely different than that shown in FIG. 8.

The disclosure presented herein may be considered in view of the following clauses:

Clause 1: In a computing environment, a method performed at least in part by a processor, comprising, obtaining data defining a symbolic finite automaton, wherein the symbolic finite automaton includes a plurality of states, the plurality of states include at least one final state and at least one non-final state; selecting at least one state of the plurality of states to be included in an initial partition, wherein the initial partition includes the at least one final state or the at least one non-final state; selecting a second set of states from the plurality of states to be included in a second partition, wherein individual states of the second set of states have transitions that lead to the at least one state included in the initial partition; if a predicate of at least one individual state of the second set of states is not equivalent to a predicate of another individual state of the second set of states, refining the second partition to create a first refining partition, and selecting at least one individual state of the second set of states to be included in the first refining partition; and generating a minimized symbolic finite automaton by unionizing the states included in the individual partitions.

Clause 2: The method of clause 1, further comprising, determining if a number of final states is equal to or fewer than a number of non-final states, and wherein the initial partition includes the at least one final state if the number of final states is equal to or fewer than the number of non-final states.

Clause 3: The method of clauses 1-2, further comprising, determining if a number of non-final states is fewer than a number of final states, and wherein the initial partition includes the at least one non-final state if the number of non-final states is fewer than the number of final states.

Clause 4: The method of clauses 1-3, further comprising, selecting a third set of states of the plurality of states to be included in a third partition, wherein individual states of the third set of states have transitions that lead to at least one state included in the second partition or the first refining partition; if a predicate of at least one individual state of the third set of states is not equivalent to a predicate of another individual state of the third set of states, refining the third partition to create a refining partition of the third partition, and selecting at least one individual state of the third set of states to be included in the refining partition of the third partition.

Clause 5: The method of clauses 1-4, wherein the second set of states comprises a second state associated with a second predicate and a third state associated with a third predicate, wherein the second predicate and the third predicate are not equivalent to the predicate of at least one individual state of the second set of states, and wherein the method further comprises: if the second predicate is not equivalent to the third predicate, refining the second partition to create a second refining partition, and selecting the second state or the third state to be included in the second refining partition.

Clause 6: The method of clauses 1-5, wherein the at least one individual state of the second set of states to be included in the first refining partition includes a plurality of selected states from the second set of states, wherein the individual states of the plurality of selected states have equivalent predicates.

Clause 7: The method of clauses 1-6, wherein unionizing the states included in the individual partitions comprises normalizing the predicates of the second set of states to define a predicate of a state of the minimized symbolic finite automaton, wherein a transition of the state of the minimized symbolic finite automaton leads to at least one final state.

Clause 8: A computer-readable storage medium having computer-executable instructions stored thereupon which, when executed by a computing device, cause the computing device to: obtain data defining a symbolic finite automaton, wherein the symbolic finite automaton includes a plurality of states, the plurality of states include at least one final state and at least one non-final state; select at least one state of the plurality of states to be included in an initial partition, wherein the initial partition includes the at least one final state or the at least one non-final state; select a second set of states from the plurality of states to be included in a second partition, wherein individual states of the second set of states have transitions that lead to the at least one state included in the initial partition; if a predicate of at least one individual state of the second set of states is not equivalent to a predicate of another individual state of the second set of states, refine the second partition to create a first refining partition, and select at least one individual state of the second set of states to be included in the first refining partition; and generate a minimized symbolic finite automaton by unionizing the states included in the individual partitions.

Clause 9: The computer-readable storage medium of clause 8, wherein the computer-executable instructions further cause the computing device to determine if a number of final states is equal to or fewer than a number of non-final states, and wherein the initial partition includes the at least one final state if the number of final states is equal to or fewer than the number of non-final states.

Clause 10: The computer-readable storage medium of clauses 8-9, wherein the computer-executable instructions further cause the computing device to determine if a number of non-final states is fewer than a number of final states, and wherein the initial partition includes the at least one non-final state if the number of non-final states is fewer than the number of final states.

Clause 11: The computer-readable storage medium of clauses 8-10, wherein the computer-executable instructions further cause the computing device to: select a third set of states of the plurality of states to be included in a third partition, wherein individual states of the third set of states have transitions that lead to at least one state included in the second partition or the first refining partition; and if a predicate of at least one individual state of the third set of states is not equivalent to a predicate of another individual state of the third set of states, refine the third partition to create a refining partition of the third partition, and select at least one individual state of the third set of states to be included in the refining partition of the third partition.

Clause 12: The computer-readable storage medium of clauses 8-11, wherein the second set of states comprises a second state associated with a second predicate and a third state associated with a third predicate, wherein the second predicate and the third predicate are not equivalent to the predicate of at least one individual state of the second set of states, and wherein the computer-executable instructions further cause the computing device to: if the second predicate is not equivalent to the third predicate, refine the second partition to create a second refining partition, and select the second state or the third state to be included in the second refining partition.

Clause 13: The computer-readable storage medium of clauses 8-12, wherein the at least one individual state of the second set of states to be included in the first refining partition includes a plurality of selected states from the second set of states, and wherein the individual states of the plurality of selected states have equivalent predicates.

Clause 14: The computer-readable storage medium of clauses 8-13, wherein unionizing the states included in the individual partitions comprises normalizing the predicates of the second set of states to define a predicate of a state of the minimized symbolic finite automaton, and wherein a transition of the state of the minimized symbolic finite automaton leads to at least one final state.

Clause 15: A computing device, comprising: a processor; and a computer-readable storage medium in communication with the processor, the computer-readable storage medium having computer-executable instructions stored thereupon which, when executed by the processor, cause the processor to obtain data defining a symbolic finite automaton, wherein the symbolic finite automaton includes a plurality of states, the plurality of states include at least one final state and at least one non-final state; select at least one state of the plurality of states to be included in an initial partition, wherein the initial partition includes the at least one final state or the at least one non-final state; select a second set of states from the plurality of states to be included in a second partition, wherein individual states of the second set of states have transitions that lead to the at least one state included in the initial partition; if a predicate of at least one individual state of the second set of states is not equivalent to a predicate of another individual state of the second set of states, refine the second partition to create a first refining partition, and select at least one individual state of the second set of states to be included in the first refining partition; and generate a minimized symbolic finite automaton by unionizing the states included in the individual partitions.

Clause 16: The computer-readable storage medium of clause 15, wherein the computer-executable instructions further cause the processor to determine if a number of final states is equal to or fewer than a number of non-final states, and wherein the initial partition includes the at least one final state if the number of final states is equal to or fewer than the number of non-final states.

Clause 17: The computing device of clauses 15-16, wherein the computer-executable instructions further cause the processor to determine if a number of non-final states is fewer than a number of final states, and wherein the initial partition includes the at least one non-final state if the number of non-final states is fewer than the number of final states.

Clause 18: The computing device of clauses 15-17, wherein the computer-executable instructions further cause the processor to: select a third set of states of the plurality of states to be included in a third partition, wherein individual states of the third set of states have transitions that lead to at least one state included in the second partition or the first refining partition; and if a predicate of at least one individual state of the third set of states is not equivalent to a predicate of another individual state of the third set of states, refine the third partition to create a refining partition of the third partition, and select at least one individual state of the third set of states to be included in the refining partition of the third partition.

Clause 19: The computing device of clauses 15-18, wherein the second set of states comprises a second state associated with a second predicate and a third state associated with a third predicate, wherein the second predicate and the third predicate are not equivalent to the predicate of at least one individual state of the second set of states, and wherein the computer-executable instructions further cause the processor to: if the second predicate is not equivalent to the third predicate, refine the second partition to create a second refining partition, and select the second state or the third state to be included in the second refining partition.

Clause 20: The computing device of clauses 15-19, wherein the at least one individual state of the second set of states to be included in the first refining partition includes a plurality of selected states from the second set of states, and wherein the individual states of the plurality of selected states have equivalent predicates.

Based on the foregoing, it should be appreciated that concepts and technologies for minimizing SFAs are presented herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims. In addition, it can be appreciated that other variations of the techniques described herein are also within the scope of the current disclosure. For instance, it can be appreciated that operations of FIG. 1 may be in a different order or, when possible, certain operations are processed in parallel.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. In a computing environment, a method performed at least in part by a processor, comprising:
obtaining data defining a symbolic finite automaton, wherein the symbolic finite automaton includes a plurality of states, the plurality of states include at least one final state and at least one non-final state;
selecting at least one state of the plurality of states to be included in an initial partition, wherein the initial partition includes the at least one final state or the at least one non-final state;
selecting a second set of states from the plurality of states to be included in a second partition, wherein individual states of the second set of states have transitions that lead to the at least one state included in the initial partition;
if a predicate of at least one individual state of the second set of states is not equivalent to a predicate of another individual state of the second set of states,
refining the second partition to create a first refining partition, and
selecting at least one individual state of the second set of states to be included in the first refining partition; and
generating a minimized symbolic finite automaton by unionizing the states included in the individual partitions.

2. The method of claim 1, further comprising, determining if a number of final states is equal to or fewer than a number of non-final states, and wherein the initial partition includes the at least one final state if the number of final states is equal to or fewer than the number of non-final states.

3. The method of claim 1, further comprising, determining if a number of non-final states is fewer than a number of final states, and wherein the initial partition includes the at least one non-final state if the number of non-final states is fewer than the number of final states.

4. The method of claim 1, further comprising:
selecting a third set of states of the plurality of states to be included in a third partition, wherein individual states of the third set of states have transitions that lead to at least one state included in the second partition or the first refining partition;
if a predicate of at least one individual state of the third set of states is not equivalent to a predicate of another individual state of the third set of states,
refining the third partition to create a refining partition of the third partition, and
selecting at least one individual state of the third set of states to be included in the refining partition of the third partition.

5. The method of claim 1, wherein the second set of states comprises a second state associated with a second predicate and a third state associated with a third predicate, wherein the second predicate and the third predicate are not equivalent to the predicate of at least one individual state of the second set of states, and wherein the method further comprises:
if the second predicate is not equivalent to the third predicate,
refining the second partition to create a second refining partition, and
selecting the second state or the third state to be included in the second refining partition.

6. The method of claim 1, wherein the at least one individual state of the second set of states to be included in the first refining partition includes a plurality of selected states from the second set of states, wherein the individual states of the plurality of selected states have equivalent predicates.

7. The method of claim 1, wherein unionizing the states included in the individual partitions comprises normalizing the predicates of the second set of states to define a predicate of a state of the minimized symbolic finite automaton, wherein a transition of the state of the minimized symbolic finite automaton leads to at least one final state.

8. A computer-readable storage medium having computer-executable instructions stored thereupon which, when executed by a computing device, cause the computing device to:
obtain data defining a symbolic finite automaton, wherein the symbolic finite automaton includes a plurality of states, the plurality of states include at least one final state and at least one non-final state;
select at least one state of the plurality of states to be included in an initial partition, wherein the initial partition includes the at least one final state or the at least one non-final state;
select a second set of states from the plurality of states to be included in a second partition, wherein individual states of the second set of states have transitions that lead to the at least one state included in the initial partition;
if a predicate of at least one individual state of the second set of states is not equivalent to a predicate of another individual state of the second set of states,
refine the second partition to create a first refining partition, and
select at least one individual state of the second set of states to be included in the first refining partition; and
generate a minimized symbolic finite automaton by unionizing the states included in the individual partitions.

9. The computer-readable storage medium of claim 8, wherein the computer-executable instructions further cause the computing device to determine if a number of final states is equal to or fewer than a number of non-final states, and wherein the initial partition includes the at least one final state if the number of final states is equal to or fewer than the number of non-final states.

10. The computer-readable storage medium of claim 8, wherein the computer-executable instructions further cause the computing device to determine if a number of non-final states is fewer than a number of final states, and wherein the initial partition includes the at least one non-final state if the number of non-final states is fewer than the number of final states.

11. The computer-readable storage medium of claim 8, wherein the computer-executable instructions further cause the computing device to:
select a third set of states of the plurality of states to be included in a third partition, wherein individual states of the third set of states have transitions that lead to at least one state included in the second partition or the first refining partition; and
if a predicate of at least one individual state of the third set of states is not equivalent to a predicate of another individual state of the third set of states,
refine the third partition to create a refining partition of the third partition, and
select at least one individual state of the third set of states to be included in the refining partition of the third partition.

12. The computer-readable storage medium of claim 8, wherein the second set of states comprises a second state associated with a second predicate and a third state associated with a third predicate, wherein the second predicate and the third predicate are not equivalent to the predicate of at least one individual state of the second set of states, and wherein the computer-executable instructions further cause the computing device to:
if the second predicate is not equivalent to the third predicate,
refine the second partition to create a second refining partition, and
select the second state or the third state to be included in the second refining partition.

13. The computer-readable storage medium of claim 8, wherein the at least one individual state of the second set of states to be included in the first refining partition includes a plurality of selected states from the second set of states, and wherein the individual states of the plurality of selected states have equivalent predicates.

14. The computer-readable storage medium of claim 8, wherein unionizing the states included in the individual partitions comprises normalizing the predicates of the second set of states to define a predicate of a state of the minimized symbolic finite automaton, and wherein a transition of the state of the minimized symbolic finite automaton leads to at least one final state.

15. A computing device, comprising:
a processor; and
a computer-readable storage medium in communication with the processor, the computer-readable storage medium having computer-executable instructions stored thereupon which, when executed by the processor, cause the processor to
obtain data defining a symbolic finite automaton, wherein the symbolic finite automaton includes a plurality of states, the plurality of states include at least one final state and at least one non-final state;
select at least one state of the plurality of states to be included in an initial partition, wherein the initial partition includes the at least one final state or the at least one non-final state;
select a second set of states from the plurality of states to be included in a second partition, wherein individual states of the second set of states have transitions that lead to the at least one state included in the initial partition;
if a predicate of at least one individual state of the second set of states is not equivalent to a predicate of another individual state of the second set of states,
refine the second partition to create a first refining partition, and
select at least one individual state of the second set of states to be included in the first refining partition; and
generate a minimized symbolic finite automaton by unionizing the states included in the individual partitions.

16. The computer-readable storage medium of claim 15, wherein the computer-executable instructions further cause the processor to determine if a number of final states is equal to or fewer than a number of non-final states, and wherein the initial partition includes the at least one final state if the number of final states is equal to or fewer than the number of non-final states.

17. The computing device of claim 15, wherein the computer-executable instructions further cause the processor to determine if a number of non-final states is fewer than a number of final states, and wherein the initial partition includes the at least one non-final state if the number of non-final states is fewer than the number of final states.

18. The computing device of claim 15, wherein the computer-executable instructions further cause the processor to:
select a third set of states of the plurality of states to be included in a third partition, wherein individual states of the third set of states have transitions that lead to at least one state included in the second partition or the first refining partition; and
if a predicate of at least one individual state of the third set of states is not equivalent to a predicate of another individual state of the third set of states,
refine the third partition to create a refining partition of the third partition, and
select at least one individual state of the third set of states to be included in the refining partition of the third partition.

19. The computing device of claim 15, wherein the second set of states comprises a second state associated with a second predicate and a third state associated with a third predicate, wherein the second predicate and the third predicate are not equivalent to the predicate of at least one individual state of the second set of states, and wherein the computer-executable instructions further cause the processor to:
if the second predicate is not equivalent to the third predicate,
refine the second partition to create a second refining partition, and select the second state or the third state to be included in the second refining partition.

20. The computing device of claim 15, wherein the at least one individual state of the second set of states to be included in the first refining partition includes a plurality of selected states from the second set of states, and wherein the individual states of the plurality of selected states have equivalent predicates.
